(19) United States
(12) Patent Application Publication
(10) Pub. No.: US 2012/0092757 A1
(43) Pub. Date: Apr. 19, 2012

(54) IMPROVED OVER-UNDER LENS FOR THREE-DIMENSIONAL PROJECTION

(75) Inventors: Mark J. Huber, Burbank, CA (US); William Gibbens Redmann, Glendale, CA (US); Jed Harmsen, Los Angeles, CA (US)

(73) Assignee: THOMSON LICENSING

(21) Appl. No.: 13/377,734

(22) PCT Filed: Dec. 15, 2009
(86) PCT No.: PCT/US09/06557

§ 371 Date: Dec. 12, 2011

Related U.S. Application Data
(60) Provisional application No. 61/269,084, filed on Jun. 19, 2009.

(51) Int. Cl. G02B 27/26

(52) U.S. Cl. 359/352; 359/465

(57) ABSTRACT

An over/under lens for projecting a 3D film print possesses a circular polarization module that includes a clockwise circular polarization filter assembly and a counterclockwise circular polarization filter assembly. The clockwise and counterclockwise circular polarization filter assemblies advantageously limit cross talk occurring between left-eye and right eye images, thus improving the viewing experience.

### CROSS-REFERENCE INFORMATION

This application claims priority under 35 U.S.C. 119(e) to U.S. Provisional Patent Application Ser. No. 61/269,084, filed 19 Jun. 2009, the teachings of which are incorporated herein.

### TECHNICAL FIELD

This invention relates to a lens and method of use for projecting images in three-dimensions. (3D).

### BACKGROUND ART

Films that display images that appear in three-dimensions (3D) have proliferated thanks in large measure to the proliferation of digital cinema projection systems capable of projecting 3D images. However, the rate of rollout of digital cinema systems has proven inadequate to keep up with demand for 3D films, especially in view of the large cost associated with retrofitting existing movie theaters.

Previously, 3D films film relied on optical techniques to obtain 3D images. Back in the 1980's, a wave of 3D films were shown in the US and elsewhere, making use of a lens and filter designed and patented by Chris Condon (U.S. Pat. No. 4,464,028), as discussed in greater detail hereinafter. Improvements to Condon 3D systems were proposed by others, such as by Lipton in U.S. Pat. No. 5,481,321. While prior 3D film systems cost considerably less that present-day digital cinema systems, such prior 3D film system suffered from difficulties, including misconfiguration, low brightness, and discoloration of the picture.

Thus, a need exists to provide high-quality film-based 3D presentations which offer image separation, color, and brightness comparable to, if not better than currently offered by digital cinema presentations.

### BRIEF SUMMARY OF THE INVENTION

Briefly, in accordance with a first embodiment of the present principles, an apparatus (e.g., a lens system) serves to transmit left-eye and right-eye images to obtain a three-dimensional image. The apparatus comprises a lens body having first and second spaced input openings and first and second spaced output openings in communication with the first and second input openings, respectively. First and second input lenses each lie proximate the first and second lens body input openings, respectively, for receiving left-eye and right-eye images, respectively, directed into the first and second lens body input openings, respectively. First and second output lenses lie proximate the first and second lens body output openings, respectively. The first and second output lenses are in optical communication with the first and second input lenses, respectively, for transmitting the left-eye and right-eye images, respectively. First and second circular polarizer filters lie adjacent to the first and second output lenses, respectively, for imparting counter-clockwise and clockwise circular polarization, respectively, to the left-eye and right-eye images transmitted by the first and second output lenses, respectively.

In accordance with another embodiment of the present principles a method for transmitting left-eye and right-eye images to obtain a three-dimensional image commences by directing the left-eye and right-eye images through first and second input lenses respectively. The left-eye and right-eye images undergo transmission from the first and second input lenses through first and second output lenses respectively. Counter-clockwise and clockwise circular polarization is imparted to the left-eye and right-eye images, respectively, transmitted by the first and second output lenses, respectively.

In accordance with yet another aspect of the present principles, an apparatus (e.g., a lens system) serves to transmit left-eye and right-eye images to obtain a three-dimensional image. The apparatus comprises a lens body having first and second spaced input openings and first and second spaced output openings in communication with the first and second input openings, respectively. First and second input lenses each lie proximate the first and second lens body input openings, respectively, for receiving left-eye and right-eye images, respectively, directed into the first and second lens body input openings, respectively. First and second output lenses lie proximate the first and second lens body output openings, respectively. The first and second output lenses lie in optical communication with the first and second input lenses, respectively, for transmitting the left-eye and right-eye images, respectively. First and second filters lie adjacent to the first and second output lenses, respectively, for imparting opposite polarizations, respectively, to the left-eye and right-eye images transmitted by the first and second output lenses, respectively. First and second high temperature UV and IR filters lie between the first and second polarizers and the first and second output lenses to reduce the incidence of polarizer heating caused by light absorption.

### BRIEF DESCRIPTION OF THE DRAWINGS

FIG. 1 depicts a symmetrical over/under 3D film segment according to the prior art;

FIG. 2 depicts an asymmetrical over/under 3D film segment according to the prior art;

FIG. 3 depicts an over-under lens in accordance with the prior art;

FIG. 4 depicts an over-under lens in accordance with a first embodiment of the present principles; and

FIG. 5 depicts an over-under lens in accordance with a first second embodiment of the present principles.

### DETAILED DESCRIPTION

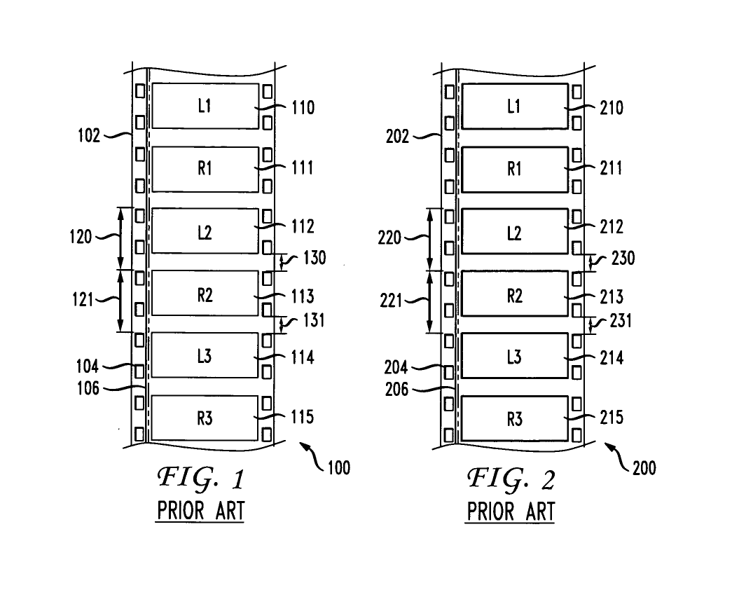

Referring to FIG. 1, a symmetrical over/under 3D film segment 100 in accordance with the prior art comprises a motion picture film 102 print (such as a 35 mm projection print film) which has rows of sprocket holes 104 along each edge. At least one optical soundtrack 106 typically lies adjacent to one of the one of the rows of sprockets.

The film segment comprises a plurality of stereoscopic image pairs. A first stereoscopic image pair comprises a left-eye image 110 of the first image pair (designated L1 in FIG. 1.); and a right-eye image 111 of the first image pair (designated R1 in FIG. 1). By previously established convention, when viewed directly, the left-eye image 110 of a pair lies on top, and the right-eye image lies on the bottom, and both images read upright. (The orientation of the film image is typically flipped when placed in a projector, since the projector's lens inverts the image when projected onto the screen.) For this reason, 3D film segments of the type described above often include the designation “over/under” film prints.

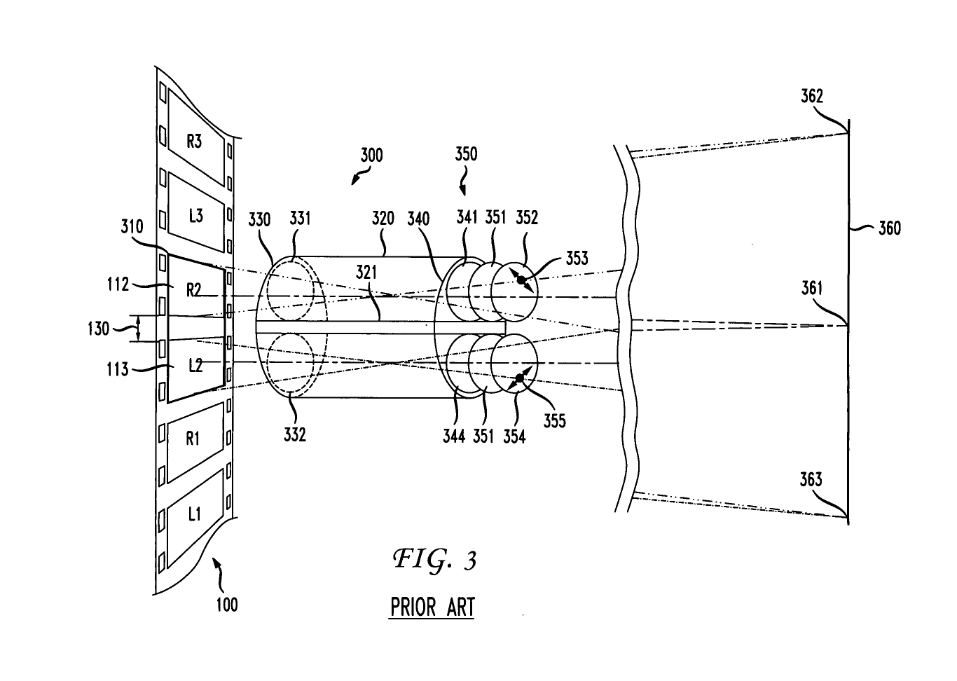

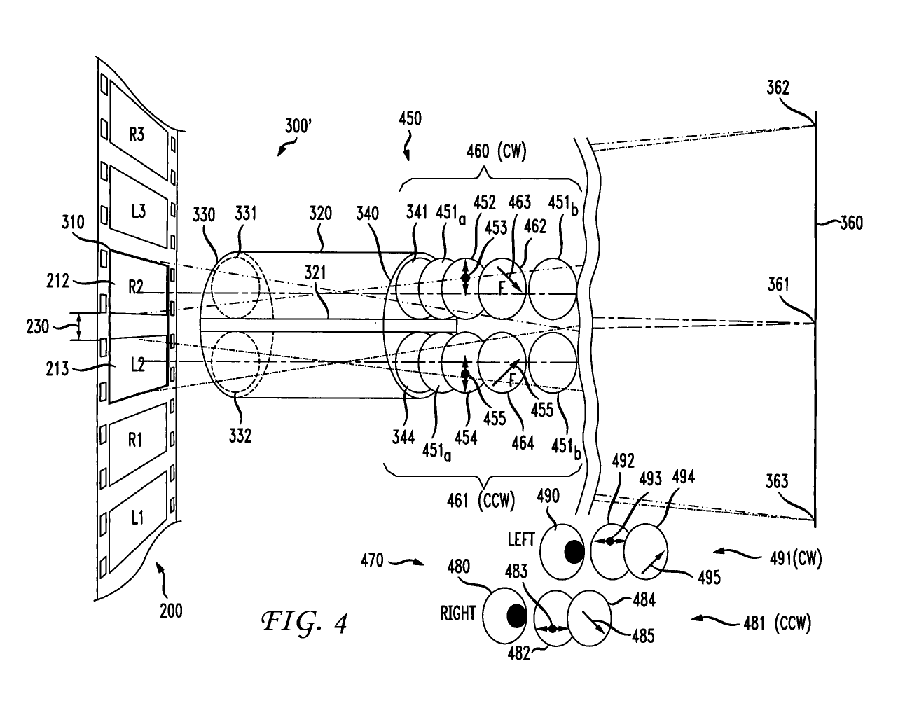

A second stereoscopic image pair comprises left-eye image 112 (designated L2 in FIG. 1) and right-eye image 113 (designated R2 in FIG. 1). Likewise, a third stereoscopic image pair comprises left-eye image 114 (designated L3 in FIG. 1) and right-eye image 115 (designated R3 in FIG. 3). The distance between the top of image 112 (left-eye image L2) and the top of right-eye image 113 (R2) corresponds to the dimension 120 in FIG. 1. Likewise, the distance between the top of image 113 (right-eye image R2) and the top of image 114 (left-eye image L3) of the next stereoscopic pair corresponds to the dimension 121.

The dimension 130 in FIG. 1 corresponds to the intra-frame gap, i.e., the distance between images of a stereoscopic pair. The dimension 131 corresponds to the inter-frame gap, i.e., or the distance between consecutive stereoscopic pairs. Typically, the inter-frame gap 131 at least equals or exceeds the minimum inter-frame gap between consecutive images in a standard 2D film. The minimum inter-frame gap for 2D film is proscribed in standards published by the Society of Motion Picture and Television Engineers, of White Planes, N.Y., for instance, SMPTE 0059-1998 Motion-Picture Film (35-mm)—Camera Aperture Images and Usage, since generally, prints for projectors are more constrained than those for cameras. For a typical symmetrical over/under print film, such as film print 100 of FIG. 1, the intra-frame gap 130 equals the inter-frame gap 131.

FIG. 2 depicts a asymmetrical over/under 3D film segment 200 according to the prior art, comprising a motion picture film 202, with rows of sprocket holes 204, and an optical sound track 206, all of which correspond substantially identically to same elements in symmetrical over/under film 100. Like the over/under 3D Film segment 100 of FIG. 1, the over/under 3D Film segment 200 of FIG. 2 comprises a plurality of left- and right-eye stereoscopic image pairs. Left-eye image 210 and right-eye image 211 (designated by L1 and R1, respectively, in FIG. 2) comprise a first stereoscopic image pair. Left-eye image 212 and right-eye image 213 (designated by L2 and R2, respectively, in FIG. 2) comprise a second stereoscopic image pair. Left-eye image 214 and right-eye image 215 (designated by L3 and R3, respectively, in FIG. 2) comprise a third stereoscopic image pair.

The dimension 220 in FIG. 2 representing the distance between the top of the images of a pair (e.g., left-eye image 212 and right-eye image 213) in the asymmetric over/under film segment 200, typically will not equal to the distance between the top of the two closest images of neighboring pairs (e.g., left-eye image 214 and right-eye image 215). Correspondingly, the intra-frame gap 230 typically will not equal the inter-frame gap 231 between consecutive stereoscopic pairs.

FIG. 3 depicts an over/under film projection system according to the prior art. An over/under projection lens system 300 lies in front of a film gate comprising an aperture 310 in the aperture plate (not shown) of a projector. (For the sake of clarity, only the inner edge of the opening in the aperture plate forming aperture 310 appears in FIG. 3) Film, in this case symmetric over/under film 100, threads behind the aperture plate 310 and in front of an illuminator (not shown) typically comprising a light source and condenser optics (not shown). Light from the illuminator floods the back of film 100, but only the portion passing through the film 100 and through aperture 310 passes into the projection lens system 300 and directed at the projection screen 360.

The over/under projection lens system 300 comprises lens body 320 having its interior bisected by septum 321. Projection lens system 300 has an input end 330 directed towards the aperture 310 and an output end 340 directed toward the projection screen 360. At input end 330, a first entrance (objective) lens 331 lies above the septum 321 and provides the projection of the right-eye images. A second entrance (objective) lens 332 lies below the septum 321 and provides the projection of the left-eye images. As discussed before, film 100 has been flipped so that the images 112 and 113 appear right-side up when projected onto screen 360. At the output end 340, a first exit lens 341 (for right-eye images) lies above septum 321 and a second exit lens 344 (for left-eye images) lies below septum 321.

The prior art lens system 300 of FIG. 3 includes a linear polarizer module 350, as taught in U.S. Pat. No. 4,464,028 to Chris Condon. The polarizer module 350 comprises absorptive linear polarizing filters 352 and 354, having orthogonally oriented axes of polarization 353 and 355, respectively. For these absorbing linear polarizers 352 and 354, the axes of polarization 353 and 355, respectively coincide with the orientation of the plane of the passed electric field, the s-wave. UV-blocking filters 351 protect each of polarizing filters 352 and 354 to limit the exposure of the polarizing filters to UV. Exposure to UV will degrade the performance of polarizing filters 352 and 354 over time causing them to discolor and lose their polarizing properties. The top and bottom halves of lens system 300 are aligned with adjustments (not shown) to allow superimposition of the left-eye image 112 and the right-eye image 113 on the projection screen 360.

When correctly superimposed through adjustments to lens system 300, the center of each of the left-eye and right-eye images 112 and 113, respectively should appear at the center 361 of the screen 360. The tops of images 112 and 113 (which are toward the bottom of film 100 in FIG. 3, due to being flipped) substantially coincide when projected at the top 362 of a screen 360. Similarly the bottoms of left-eye and right-eye images 112 and 113, respectively (which are toward the top of film 100 in FIG. 3) substantially coincide at the bottom 363 of screen 360. Since the left- and right-eye images projected onto screen 360 are encoded with polarization of the projected light, the screen 360 must preserve polarization. For this reason, the screen 360 typically comprises a silver screen designed for this purpose.

To view the stereoscopic images projected through linear polarization module 350 of lens system 300 of FIG. 3, individual viewers in the audience must wear linearly polarized glasses (not shown in FIG. 3) with separate left- and right-eye polarized filters. Since both the projector and the audience face the screen 360 from the same side, the orientation of the polarization used to project the image for a particular eye maintains the polarization angle when reflected off of the screen 360.

If the polarization axis of right-eye image polarizing filter 352 coincides with the vertical axis, the mirror image appears vertical, so the right-eye of the viewer would wear a polarizer with a vertical axis of polarization. Similarly, if the polarization axis of the left-eye polarizing filter 354 coincides with the horizontal axis, the mirror image also appears horizontal, so the left-eye of the viewer would wear a polarizer with a horizontal axis of polarization. Thus, the viewer's s right-eye would see the right-eye image through the vertical polarizer, but block the left-eye image, which has an orthogonal (horizontal) polarization.

If the polarization axis 353 of right-eye polarizer 352 does not coincide with either vertical or horizontal axes, but lies along a diagonal, say 45 degrees clockwise from vertical axes when facing the screen 360, then the orientation of the glasses' right-eye polarizer lies along the same diagonal, that is, 45 degrees clockwise from vertical axes when facing the screen when viewed by the wearer. The polarizer 354 for the left-eye image projection has its axis 355 orthogonal to that of the axis 353, which in this example lies 45 degrees counterclockwise from vertical when facing the screen. The left-polarizer of the glasses worn by the view would have a similar orientation, and therefore lie orthogonal to the orientation of the glasses' right-eye polarizer.

Projection of the symmetrical over/under film 100 through the lens 300 commonly suffers from the drawback that light passing through the left-eye image 113 near the intra-frame gap 130 may cross over into input lens 331 and result in excess scatter light within the upper half of lens 330 that reduces the contrast of the right-eye image, or that light actually could be imaged by the lens and projected onto the screen above point 362, which can distract the audience. Similarly, light passing through image 112 near intra-frame gap 130 may cross over into input lens 332 and end up reducing contrast of the left-eye image 113 as projected, and/or actually being projected onto the screen below point 363.

In addition to the cross-talk, prior art over-under lenses, such as lens 300 of FIG. 3 also suffer from the problem that the linear polarizer filters 352 and 354 tend to overheat from absorption of light. Polarizer overheating can lead to premature failure, necessitating replacement of the lens.

FIG. 4 depicts an improved over/under projection lens 300′ in accordance with a first embodiment of the present principles. Lens 300′ of FIG. 4 possesses features in common with the lens 300 of FIG. 3 and like reference numerals appear in FIG. 4 to describe like elements. The lens 300′ of FIG. 4 differs from lens 300 of FIG. 4 in the following manner. In particular, lens 300′ of FIG. 4 includes a circular polarization module 450 in place of the linear polarization module 350 of lens 300 of FIG. 3.

Referring to FIG. 4, the circular polarization module 450 comprises a clockwise circular polarization filter assembly 460 for projecting the right-eye image, and a counterclockwise circular polarization filter assembly 461 for projecting the left-eye image. The clockwise (e.g., the “right” or “right-handed”) circular polarization filter assembly 460 comprises a high temperature glass UV and IR reflecting filter 451ₐ, a linear polarizer 452 having vertical axis of polarization 453, and a broadband, visible light quarter-wave plate 462 having its fast axis 463 oriented 45° clockwise from polarization axis 453 when facing the screen.

The counterclockwise (or “left” or “left-handed”) circular polarization filter assembly 461 comprises a first high temperature glass UV and IR reflecting filter 451ₐ, a linear polarizer 452 having vertical axis of polarization 455 the same as in polarization filter assembly 460, and a broadband, visible light quarter-wave plate 464 having its fast axis 465 oriented 45° counterclockwise from polarization axis 455 when facing the screen

In accordance with the present principles, the presence of the first high temperature glass UV and IR reflecting filter 451ₐ serves to reflect the UV and IR light back to the light source, thereby reducing the incidence of polarizer heating. In addition, the first high temperature glass UV and IR reflecting filter 451_{a,} tends to absorb heat as well, which also tends to reduce the incidence of heating of the linear polarizer 452 and quarter-wave plate 464. Note that the heat reducing property of the glass filter 451ₐ makes it advantageous to include such a filter in lenses (not shown) embodying linear polarizers, such as the lens 300 of FIG. 3.

In some embodiments, a second high temperature glass filter 451_{b} can cover and protect the exit face of polarization filter assemblies 460 and 461 to further reduce the incidence of polarizer heating. In still other embodiments, each polarizer filter assembly could comprise a second broadband, visible light quarter-wave plate (not shown) having its fast axis oriented orthogonally to the orientation of the fast axis of the other quarter-wave plate in the same polarizer filter assembly. In this embodiment, the circular polarization of the left-eye and right-eye circular polarization filter assemblies 461 and 461 remains consistent, even when the individual modules are installed facing the wrong way. For this configuration, a viewer 470 would wear glasses (not shown) comprising counterclockwise circular analyzer 481 over the viewer's right eye 480, and clockwise circular analyzer 491 over the viewer's left eye 490.

The counterclockwise circular analyzer 481 for right eye 480 comprises a quarter-wave plate 484 having its fast axis 485 oriented in the same direction 463 of quarter-wave plate 462 in corresponding right-eye circular polarizing module 460. A linear polarizer 482 lies between the quarter-wave plate 484 and right eye 480 of the viewer 470. The polarization axis 483 of linear polarizer 482 lies 45° counterclockwise proceeding from the screen 360 toward the right eye 480, making a counterclockwise circular polarizer. In this configuration, the polarization axis 483 lies orthogonal to polarization axis 453.

The clockwise circular analyzer 491 for left eye 490 comprises a quarter-wave plate 494 having its fast axis 495 oriented in the same direction 465 of quarter-wave plate 464 in corresponding left-eye circular polarizing module 461. A linear polarizer 492 lies between the quarter-wave plate 494 and left eye 490 of audience member 470. The polarization axis 493 of linear polarizer 492 lies 45° clockwise proceeding from the screen 360 toward the left eye 490, making a clockwise circular polarizer. In this configuration, polarization axis 493 is orthogonal to polarization axis 455.

Note that while the right-eye image is projected through clockwise circular polarizing filter assembly 460, the viewer's right eye 480 views screen 360 through the counterclockwise analyzer 481. This is because, by analogy, the screen 360 acts as a mirror, and viewing and image clockwise through a mirror makes the image appear counterclockwise. Thus, the light passing through right-eye image 212 and circular polarizer filter assembly 460 is circularly polarized in the clockwise direction, but after bouncing off of screen 360, the light becomes circularly polarized in the counterclockwise direction. The light then passes through counterclockwise circular analyzer 481 of the glasses for viewing by the viewer's right eye 480. The same Likewise the light will pass through the circular analyzer 491, but reversed, for the left-eye image being viewed by the left eye.

Note that FIG. 4 depicts an asymmetrical over/under film segment 200 so that an increased intra-frame gap 230 will reduce if not eliminate the spill from the portions of the left-eye and right-eye images 212 and 213, respectively, near the intra-frame gap 230 into the input lenses 332 and 331 corresponding to the other image, thereby minimizing contrast reduction and phantom images above and below the screen, as described in conjunction with FIG. 3.

The glasses being worn by viewer 470 typically comprise those manufactured by Real-D, Inc of Beverly Hills, Calif. However, such glasses have a drawback caused by their common orientation of axes of polarization 483 and 493. Further, the orientation of the fast axes 485 and 495 of such glasses matches the orientation of fast axes 463 and 465, respectively, of the corresponding quarter-wave plates 462 and 464, respectively; in circular polarization filter assemblies 460 and 461, respectively. Such axes matching results from cumulative retardation. As polarized light passes from the linear polarizer 452 through the first quarter-wave plate 462, the component of the electric field in the fast axis 463 emerges 90° advanced with respect to the component of the electric field that lies in the orthogonal (slow) axis. Stated another way, the electric field in the slow axis is 90° retarded with respect to the fast axis 463.

Having bounced off the screen 360 and encountering the analyzer module 481, the light then passes through the quarter-wave plate 485 with its fast axis 485 aligned with the fast axis 463. Thus the component of the electric field aligned with the fast axis emerges yet another 90° advanced with respect to the component in the slow axis, for a cumulative 180° advance (or, conversely, the slow axis has been 180° retarded). Unfortunately, neither quarter-wave plate 462 or 484 is achromatic, that is, neither precisely retards by 90° for all frequencies of light. As a result, some frequencies of light are retarded a little more, and some a little less, and by whatever amount they differ in a single quarter-wave plate, the amount is doubled having passed through two such plates.

Thus, some frequencies get retarded by 181° and some by 179°. For those frequencies of light which are substantially 180° retarded, the resulting polarization is substantially linear and parallel to the linear axis of polarization 493. For those frequencies that deviate from 180° retarded, the resulting polarization is slightly elliptical and a portion of the light at those frequencies will pass through the linear polarizer 492, resulting in a diminution of light at those frequencies, resulting in a filter-dependent tint being applied by the filters.

Linear polarization is preferred for display of 3D film in theme parks because they do not suffer from this tinting. However, when a viewer tilts his or her head to the side, the linear polarizing filters will crosstalk. Such crosstalk remains a minor issue in theme parks because the theatrical shows are short, and viewers can sit upright for a short while. However, in movie theater venues, shows are longer and most viewers cannot comfortably keep their heads upright for such a long time. Thus, for most theatrical venues, circular polarization limits the crosstalk between eyes for even large head tilts. An additional tint could be imposed if the linear polarizers 452, 454, 482, and 492 are other than a neutral density.

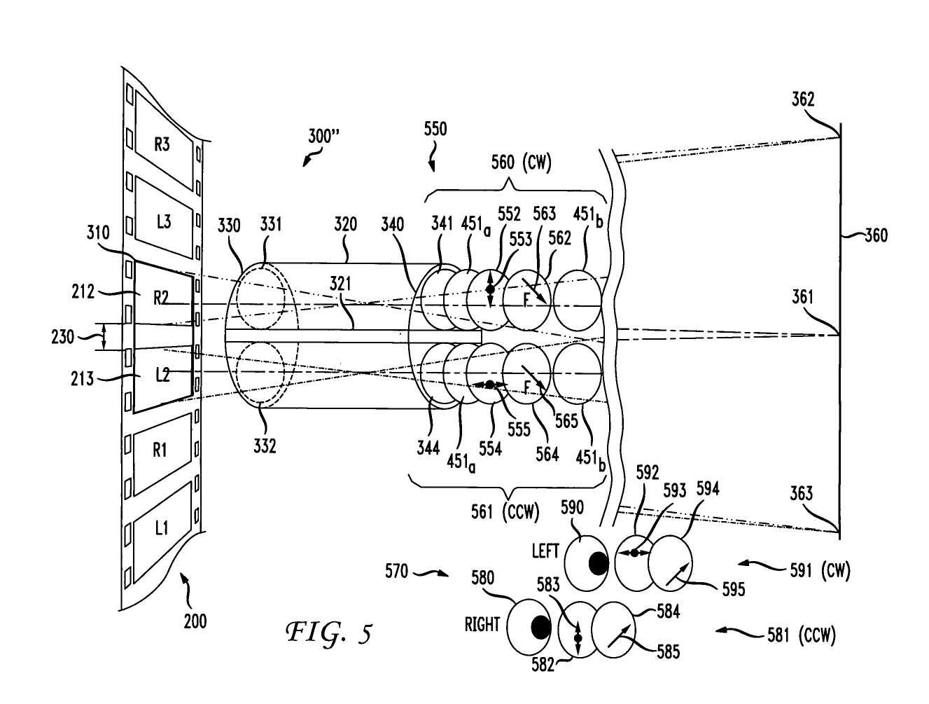

FIG. 5 depicts an improved over/under projection lens 300″ in accordance with a first embodiment of the present principles. Lens 300″ of FIG. 5 possesses features in common with the lenses 300 and 300′ of FIGS. 3 and 4, respectively, and like reference numerals appear in FIG. 5. The lens 300″ of FIG. 5 differs from lens 300′ of FIG. 4 by virtue of a circular polarization module 550 that overcomes the discoloration drawback of the circular polarization module 450 of lens 300′.

The circular polarization module 550 of lens 300″ of FIG. 5 comprises of a clockwise circular polarization filter assembly 560 for projecting the right-eye image, and a counterclockwise circular polarization filter assembly 561 for projecting the left-eye image. The clockwise (e.g., the “right” or “right-handed”) circular polarization filter assembly 560 comprises a high temperature glass UV and IR reflecting filter 451ₐ, a linear polarizer 552 having vertical axis of polarization 553, and a broadband, visible light quarter-wave plate 562 having its fast axis 563 oriented 45° clockwise from polarization axis 553 when facing the screen.

The counterclockwise (or “left” or “left-handed”) circular polarization filter assembly 561 comprises a high temperature glass UV and IR reflecting filter 451ₐ, a linear polarizer 554 having vertical axis of polarization 555 orthogonal to axis of polarization 553 of the circular polarization module 560, and a broadband, visible light quarter-wave plate 564 having its fast axis 465 oriented 45° counterclockwise from polarization axis 555 when facing the screen, forming a counterclockwise circular polarizer. In some embodiments, a second high temperature glass filter 451_{b} may cover and protect the other face of module 460. As discussed with the lens 300′ of FIG. 4, the filters 451ₐ and 451_{b} in lens 400 of FIG. 5 reduce the incidence of polarizer heating.

A viewer 570 wears 3D glasses comprising right-eye counterclockwise circular polarization analyzer 581 covering his right eye 580, and left-eye clockwise circular polarization analyzer 591 covering his left eye 590. Right-eye counterclockwise circular polarization analyzer 581 comprises quarter-wave plate 584 having fast axis 585 oriented orthogonally to fast axis 563, and linear polarizer 582 with axis of polarization oriented 45° counterclockwise with respect to fast axis 585, when viewed from the screen. Left-eye clockwise circular polarization analyzer 591 comprises quarter-wave plate 594 having fast axis 595 oriented orthogonally to fast axis 565, and linear polarizer 592 with axis of polarization oriented 45° clockwise with respect to fast axis 595, when viewed from the screen.

For the lens 300″ of FIG. 5, the projection filter for a particular eye image (e.g., right-eye image 212) will have crossed linear polarizers with respect the projection filter for the other eye. Both projection filters will have the same orientation of quarter-wave plate fast axes, in fact, the quarter-wave plates 563 and 565 can be merged and become a single piece for simplicity of manufacture. Similarly, both quarter-wave plates in the glasses of audience member 570 have a common orientation to the fast axis of the quarter-wave plates. The linear polarizers of the glasses have axes of polarization that are orthogonal to each other.

The discoloration described with respect to the lens 300′ shown in FIG. 4 is reduced if not eliminated by the lens 300″ of FIG. 6 because the projector filter and glasses quarter-wave plates for a particular eye have their fast axes lying at 90° to each other. For instance, light from the right-eye image 212 is polarized by polarizer 552. From there, the component of the electric field aligned with fast axis 563 of quarter-wave plate 562 becomes advanced with respect to the orthogonal component by 90°. Due to the imperfect chromatic behavior, some frequencies of light become advanced a little more, some a little less, resulting in a clockwise, mostly circular polarization. After reflecting off of screen 360, the light now possesses a counterclockwise, mostly circular polarization upon encountering the quarter-wave plate 584 with a fast axis 585 that is orthogonal to fast axis 563. Thus, the component of the light that previously aligned with the fast axis 563 is now orthogonal to fast axis 585. If the optical properties of quarter-wave plates 562 and 584 are identical, then those components of light that were advanced by 90° with respect to the orthogonal components, are now retarded by 90° with respect to the orthogonal components, for a net of 0°. Those frequencies whose advancement was a bit more or less than 90° are retarded now by the same bit more or less than 90°, here too, for a net of 0°. Thus, the lens 300″ of FIG. 5 yields little or no discoloration due to the effects of the imperfectly achromatic quarter-wave plates 563, 565, 584, and 594.

The foregoing describes a over/under lens for projecting 3D film that offers improved performance over prior art lens by using circular polarization.

1. Apparatus for transmitting left-eye and right-eye images to obtain a three-dimensional image, comprising:
a lens body having first and second spaced input openings and first and second spaced output openings in communication with the first and second input openings, respectively;
first and second input lenses each positioned proximate the first and second lens body input openings, respectively, for receiving left-eye and right-eye images, respectively, directed into the first and second lens body input openings, respectively;
first and second output lenses positioned proximate the first and second lens body output openings, respectively, the first and second output lenses in optical communication with the first and second input lenses, respectively, for transmitting the left-eye and right-eye images, respectively; and
first and second circular polarizer filters adjacent to the first and second output lenses, respectively, for imparting counter-clockwise and clockwise circular polarization, respectively, to the left-eye and right-eye images transmitted by the first and second output lenses, respectively.

2. The apparatus according to claim 1 wherein each of the first and second circular polarizer filters comprises:
a filter for reflecting ultraviolet and infrared light;
a linear polarizer having a vertical axis of polarization;
a visible light quarter-wave plate having a fast axis oriented 45° from vertical axis of the linear polarizer in a one of a clockwise or counter-clockwise direction when facing the image transmitted by one of the first and second circular polarizers,
whereas the quarter wave-plate of the other of the first and second polarizers has its fast axis oriented 45° from vertical axis of the linear polarizer in the other one of the clockwise or counter-clockwise direction.

3. The apparatus according to claim 2 wherein the light-reflecting filter comprises high temperature glass.

4. The apparatus according to claim 2 further comprising a second light-reflecting filter adjacent to the quarter-wave plate.

5. The apparatus according to claim 2 wherein the linear polarizers of the first and second circular polarizer filters has have their vertical axis of polarization aligned with each other.

6. The apparatus according to claim 2 wherein the linear polarizer of the first and second circular polarizer filters have their vertical axis of polarization opposed to each other.

7. Apparatus for transmitting left-eye and right-eye images to obtain a three-dimensional image, comprising:
a lens body having first and second spaced input openings and first and second spaced output openings in communication with the first and second input openings, respectively;
first and second input lenses each positioned proximate the first and second lens body input openings, respectively, for receiving left-eye and right-eye images, respectively, directed into the first and second lens body input openings, respectively;
first and second output lenses positioned proximate the first and second lens body output openings, respectively, the first and second output lenses in optical communication with the first and second input lenses, respectively, for transmitting the left-eye and right-eye images, respectively;
first and second polarizers adjacent to the first and second output lenses, respectively, for imparting opposing polarizations to the left-eye and right-eye images transmitted by the first and second output lenses, respectively;
wherein the first and second polarizers include a filter for reflecting ultraviolet and infra red light to reduce the incidence of polarizer heating.

8. The apparatus according to claim 1 wherein each of the first and second circular polarizer filters comprises:
a filter for reflecting ultraviolet and infrared light;
a linear polarizer having a vertical axis of polarization;
a visible light quarter-wave plate having a fast axis oriented 45° from vertical axis of the linear polarizer in a one of a clockwise or counter-clockwise direction when facing the image transmitted by one of the first and second circular polarizers,
whereas the quarter wave-plate of the other of the first and second polarizers has its fast axis oriented 45° from vertical axis of the linear polarizer in the other one of the clockwise or counter-clockwise direction.

9. The apparatus according to claim 8 further comprising a second light-reflecting filter adjacent to the quarter-wave plate.

10. The apparatus according to claim 8 wherein the linear polarizers of the first and second polarizer filters has have their vertical axis of polarization aligned with each other.

11. The apparatus according to claim 8 wherein the linear polarizer of the first and second polarizer filters have their vertical axis of polarization opposed to each other.

12. A method for transmitting left-eye and right-eye images to obtain a three-dimensional image, comprising:
directing the left-eye and right-eye images through first and second input lenses respectively;
transmitting the left-eye and right-eye images from the first and second input lenses through first and second output lenses respectively; and
imparting counter-clockwise and clockwise circular polarization, respectively, to the left-eye and right-eye images transmitted by the first and second output lenses, respectively.

13. The method according to claim 1 further including the step of filtering the left-eye and right-eye image to reflect ultraviolet and infra light in an direction opposite to transmission of the images into the first and second output lenses.

14. A method for transmitting left-eye and right-eye images to obtain a three-dimensional image, comprising:
directing the left-eye and right-eye images through first and second input lenses respectively;
transmitting the left-eye and right-eye images from the first and second input lenses through first and second output lenses respectively;
filtering the left-eye and right-eye image to reflect ultraviolet and infra light in an direction opposite to transmission of the images into the first and second output lenses and
imparting opposing polarizations, to the left-eye and right-eye images transmitted by the first and second output lenses, respectively.
